(19) United States
(12) Patent Application Publication
(10) Pub. No.: US 2008/0291015 A1
(43) Pub. Date: Nov. 27, 2008

(54) Ambient Light Sensor to Adjust Display Brightness

(76) Inventor: Steven T. Charles, Memphis, TN (US)

Correspondence Address: ALCON, IP LEGAL, TB4-8, 6201 SOUTH FREEWAY, FORT WORTH, TX, 76134, US

(21) Appl. No.: 11/753,995

(22) Filed: May 25, 2007

(51) Int. Cl. G08B 21/00

(52) U.S. Cl. 340/540

(57) ABSTRACT

A system for automatically adjusting the display intensity and/or illumination of surgical console controls and indicators. The invention includes a light sensor to detect the level of ambient light as well as a microprocessor with settings for ambient light threshold level and dimming amount.

### BACKGROUND OF THE INVENTION

The human eye can suffer a number of maladies causing mild deterioration to complete loss of vision. While contact lenses and eyeglasses can compensate for some ailments, ophthalmic surgery is required for others. Generally, ophthalmic surgery is classified into posterior segment procedures, such as vitreoretinal surgery, and anterior segment procedures, such as cataract surgery. More recently, combined anterior and posterior segment procedures have been developed.

The surgical instrumentation used for ophthalmic surgery can be specialized for anterior segment procedures or posterior segment procedures or support both. In any case, the surgical handpieces and instruments often require the use of an associated surgical console connected to the surgical handpiece by fluid tubing and/or control cables. The surgical console provides a centralized system for monitoring and/or controlling the procedure. Such a surgical console can be quite complex and contain many backlit displays, indicator LEDs, and controls.

In the case of vitreoretinal surgery, the procedure usually is performed in a darkened room, to reduce interference attributable to ambient light and allow the surgeon to view the finer structures of the retina and inner eye. When operating in a darkened room, many surgeons prefer to reduce the intensity of the console display illumination so as not to interfere with his or her ability to view the retina and eye. In prior art consoles, this was accomplished through manual adjustment of the display intensity. As the surgical console is not sterile, manual adjustments to the console must be made by a non-sterile technician or circulating nurse, who may be responsible for covering more than one operating room. Therefore, when an adjustment is needed, the surgeon may have to wait while the appropriate personnel are called.

Accordingly, a need continues to exist for an ophthalmic microsurgical console capable of continuous, automatic regulation of display intensity based upon the level of ambient lighting.

### BRIEF SUMMARY OF THE INVENTION

The present invention improves upon prior art by providing a system for automatically adjusting the display intensity and/or illumination of surgical console controls and indicators. The invention includes a light sensor to detect the level of ambient light as well as a microprocessor with settings for ambient light threshold level and dimming amount.

It is accordingly an objective of the present invention to provide an ophthalmic microsurgical console that automatically adjusts the display illumination intensity.

It is a further objective of the present invention to provide an ophthalmic microsurgical console that has a light sensor capable of sensing ambient light levels.

It is a further objective of the present invention to provide an ophthalmic microsurgical console that has a microprocessor and related software to store preset constants for ambient light threshold level and dimming amount.

It is further an objective of the present invention to provide an ophthalmic microsurgical console that does not require manual adjustment of display illumination intensity.

It is another an objective of the present invention to provide an ophthalmic microsurgical console that continously adjusts the display illumination intensity.

Other objectives, features and advantages of the present invention will become apparent with reference to the drawings, and the following description of the drawings and claims.

### BRIEF DESCRIPTION OF THE DRAWINGS

FIG. 1 is a block diagram of the display control system of the present invention.

FIG. 2 is a side elevational view of the light sensor of the present invention.

FIG. 3 is a side perspective view of the surgical console of the present invention.

FIG. 4 is a flow diagram illustrating the operation of the display intensity control system of the present invention.

### DETAILED DESCRIPTION OF THE PREFERRED EMBODIMENTS

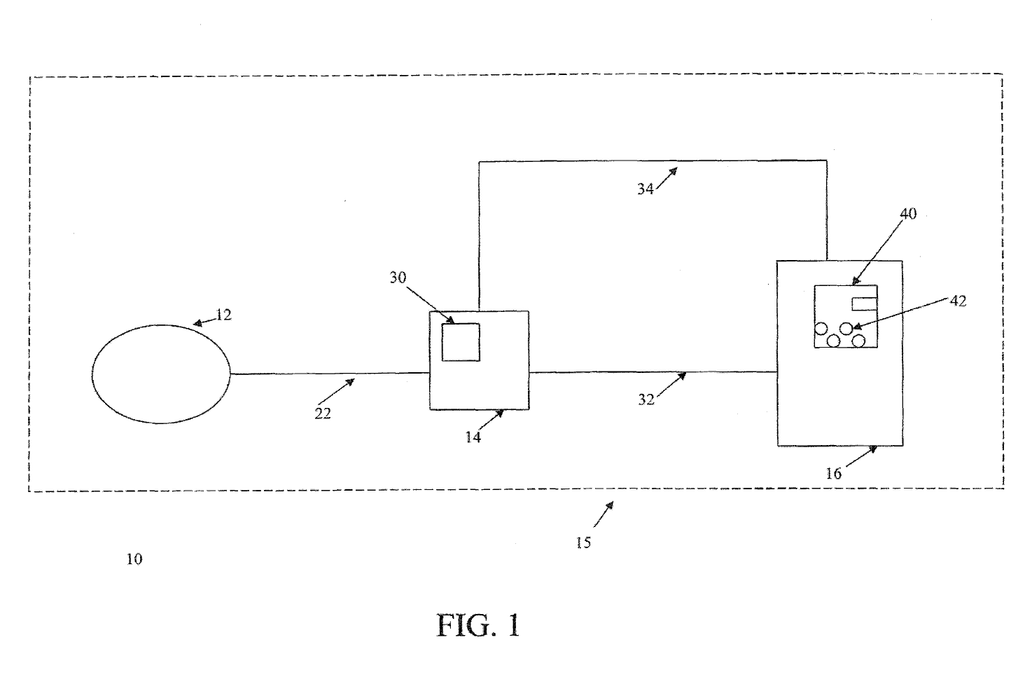

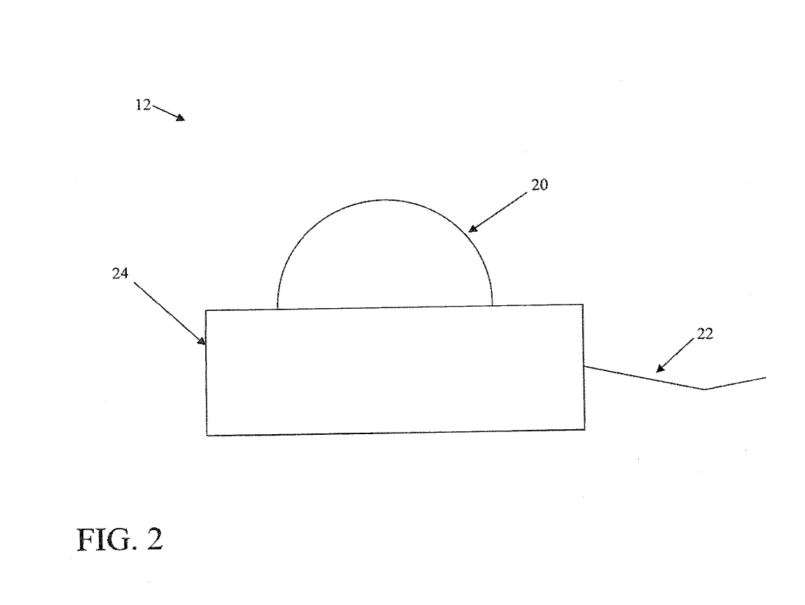

As best seen in FIG. 1, system 10 of the present invention generally includes light sensor 12, microprocessor 14, preferably contained within surgical console 15. Sensor 12 may be any type of light sensor, such as a photo-sensitive cell or phototransistor. Examples include a photoelectric cells, photovoltaic cells, but is most preferably a photodiode, PIN photodiode, or avalanche photodiode such as the S9717-05L silicon avalanche photodiode sold by Hamamatsu Photonics, K. K., Hamamatsu City, Japan. As best seen in FIG. 2, sensor 12 comprises lens 20, electrical connection 22, and base 24. Lens 20 is most preferably a dome-shaped optical lens with an entrance angle approaching 360 degrees. Sensor 12 is electrically connected to microprocessor 14 via electrical connection 22.

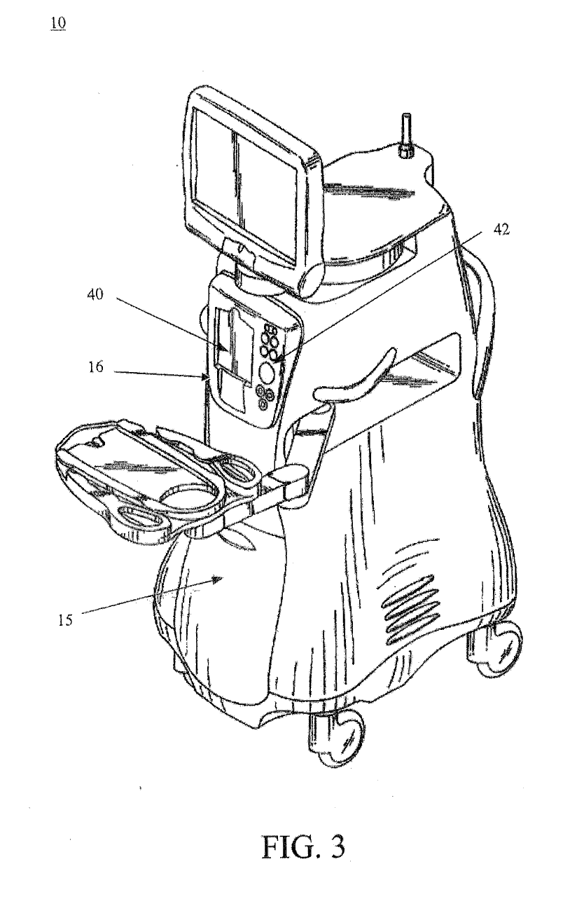

Sensor 12 and microprocessor 14 may be stand alone devices, but are most preferably integrated within surgical console 15 as illustrated in FIG. 1. Microprocessor 14 has the capability of storing a plurality of factory preset or user selectable settings, such as a threshold ambient light level, a dimming amount, and dimming speed or any other desired parameter. Microprocessor 14 also comprises user interface 30, as shown in FIG. 3. Interface 30 allows the adjustment of the factory preset or user selectable settings. Microprocessor 14 is electrically connected to surgical console via electrical connections 32 and 34.

Surgical console 15, may be any type of surgical console, but is most preferably an ophthalmic microsurgical console such as the ACCURUS® surgical system sold by Alcon Laboratories, Inc., Fort Worth, Tex. Surgical console 15 contains control panel 16 having display 40, which generally includes a plurality of controls, displays, and/or indicators 42. At least some of controls 42 may be illuminated, such as by backlighting or some other illumination means, for increased visibility.

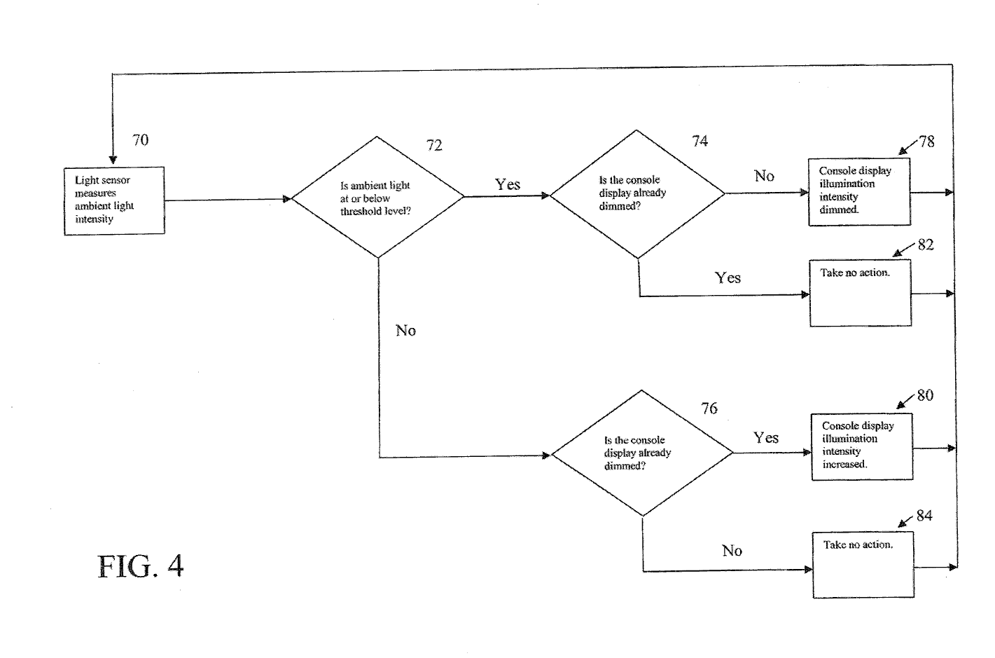

During operation, as best shown in FIG. 4, sensor 12 continuously detects the level of ambient light in the room, as shown in step 70. Sensor 12 converts the ambient light intensity to an electrical signal and transmits this signal to microprocessor 14 via electrical connection 22. In step 72, microprocessor 14 compares the ambient light intensity to the desired threshold value. If ambient light is at or below the threshold level, microprocessor 14 will then determine if controls 42 have already been dimmed, as illustrated in step 74. If controls 42 have not been dimmed, step 78 illustrates that microprocessor 14 will signal surgical console 15 to dim the illumination of controls 42. If the console has already been dimmed, no action is needed, as shown in step 82. On the other hand, if ambient light is not at or below the threshold level, microprocessor 14 will again determine if controls 42 have already been dimmed, as illustrated in step 76. If controls 42 have already been dimmed, microprocessor 14 will signal console 15 to increase the intensity of controls 42 illumination, as shown in step 80. Likewise, if controls 42 are not already dimmed, no action is required as shown in step 84.

There are several alternative embodiments to the present invention. In one alternative embodiment, additional settings, representing additional threshold ambient light levels, are stored in microprocessor 14. This results in system 10 providing step-wise dimming as ambient light drops below each successive threshold. A second alternative embodiment includes a setting stored in microprocessor 14 that would control the speed of dimming. Such a setting allows the surgeon to adjust between a rapid change in illumination intensity and a more gradual change. In a third alternative embodiment, a setting is added to microprocessor 14 that allows display intensity to increase or decrease in different increments. Such a setting may be useful when a surgeon wants a rapid decrease from bright to dim, but desires a gradual increase from dim to bright, or vice versa.

While certain embodiments of the present invention have been described above, these descriptions are given for purposes of illustration and explanation. Variations, changes, modifications and departures from the systems and methods disclosed above may be adopted without departure from the scope or spirit of the present invention.

I claim:

1. A surgical system comprising:
a) a console;
b) at least one illuminated control associated with the console;
c) a light sensor having an output, the light sensor being connected to the console;
d) a microprocessor connected to the light sensor and the console; the microprocessor capable of storing a plurality of settings and adjusting an intensity of the control illumination based upon a comparison of the output from the light sensor and the stored settings.

2. The system of claim 1 wherein the microprocessor is capable of continuously adjusting the intensity of the control illumination.

3. The system of claim 1 wherein the settings are factory presets.

4. The system of claim 3 wherein one of the factory preset settings comprise at least a threshold ambient light level.

5. The system of claim 3 wherein the preset threshold settings comprise at least a plurality of threshold ambient light settings.

6. The system of claim 3 wherein one of the factory preset settings comprise at least a dimming amount.

7. The system of claim 3 wherein one of the factory preset settings comprise at least a dimming rate.

8. The system of claim 1 wherein the settings are user defined.

9. The system of claim 8 wherein one of the user defined settings comprise at least a threshold ambient light level.

10. The system of claim 8 wherein the user defined settings comprise at least a plurality of threshold ambient light settings.

11. The system of claim 8 wherein one of the user defined settings comprise at least a dimming amount.

12. The system of claim 8 wherein one of the user defined settings comprise at least a dimming rate.

13. The system of claim 1 wherein the light sensor comprises a photodiode.

14. The system of claim 13 wherein the light sensor comprises a domed shaped optical lens.

15. The system of claim 1 wherein the light sensor comprises a photoelectric cell.

16. The system of claim 15 wherein the light sensor comprises a domed shaped optical lens.

17. The system of claim 1 wherein the light sensor comprises a photovoltaic cell.

18. The system of claim 17 wherein the light sensor comprises a domed shaped optical lens.

19. A method for continuously controlling an intensity of a surgical console control illumination comprising the steps of:
a) providing a console having a microprocessor and at least one illuminated control;
b) measuring an intensity of ambient light using a light sensor, the light sensor being in communication with the microprocessor;
c) using the microprocessor to compare the intensity of ambient light to a threshold setting;
d) adjusting the intensity of the control illumination based on the comparison of the intensity of the ambient light to the threshold setting.

20. The method of claim 19 wherein increased intensity adjustments in the control illumination are made in a different increment than decreased intensity adjustments in the control illumination.

21. The method of claim 19 wherein the threshold setting comprises a factory preset setting.

22. The method of claim 19 wherein the threshold setting comprises a plurality of threshold settings.

23. The method of claim 19 wherein the threshold setting comprises a user defined setting.

24. The method of claim 19 wherein the adjustment of the intensity of the control illumination intensity is made at a user defined rate.

25. The method of claim 19 wherein the adjustment of the intensity of the control illumination intensity is made at a factory preset rate.

26. The method of claim 19 wherein the adjustment of the intensity of the control illumination is made continuously.

27. The method of claim 19 wherein the threshold setting includes at least a dimming amount.

28. The method of claim 19 wherein the threshold setting includes at least a dimming rate.

29. The method of claim 19 wherein the threshold setting includes at least a threshold ambient light.

30. The method of claim 19 wherein the threshold setting includes at least a plurality of threshold ambient light settings.
